(19) United States
(12) Patent Application Publication
(10) Pub. No.: US 2026/0120626 A1
(43) Pub. Date: Apr. 30, 2026

(54) GATE DRIVER AND ELECTRONIC DEVICE INCLUDING THE SAME

(71) Applicant: SAMSUNG DISPLAY CO., LTD., YONGIN-SI (KR)

(72) Inventors: KYUNGHO KIM, Yongin-si (KR); BYUNGCHANG YU, Yongin-si (KR); JINJOO HA, Yongin-si (KR)

(21) Appl. No.: 19/286,472

(22) Filed: Jul. 31, 2025

(30) Foreign Application Priority Data
Oct. 31, 2024 (KR) 10-2024-0152128

(51) Int. Cl. G09G 3/32

(52) U.S. Cl. CPC G09G 3/32; G09G 2310/0267; G09G 2310/08

(57) ABSTRACT

A gate driver comprises a plurality of stages. Each of the stages comprises a CQ node charging circuit, a first CQS node charging circuit, a second CQS node charging circuit, a QB node control circuit, a CQ node boosting circuit, and a gate output circuit which outputs first to P-th (where P is a positive integer greater than or equal to 2) gate clock signals as first to P-th gate signals. The stages receive first to Q-th (where Q is a positive integer greater than P) gate clock signals. Q may be a minimum value among Q values which satisfy a condition that a duration in which a Q+1-th gate signal of a second stage is output is separated from a duration in which a voltage of a CQ node of a first stage has a high level.

This application claims priority under 35 U.S.C. § 119 to Korean Patent Application No. 10-2024-0152128, filed on October 31, 2024, the entire disclosure of which is incorporated by reference herein in its entirety.

### TECHNICAL FIELD

Embodiments of the present inventive concept relate to a gate driver and an electronic device including the same. More particularly, embodiments of the present inventive concept relate to a gate driver and an electronic device including the same for supporting a Dual Line Gate (DLG) mode.

### DISCUSSIONS OF RELATED ART

Recently, display devices have been developed that support Dual Line Gate (DLG) mode. In DLG mode, two adjacent gate lines are driven simultaneously in order to increase the driving frequency of the display panel. For example, a display device that normally operates at 60 Hz may use DLG mode to achieve a refresh rate of 120 Hz.

A display device operating in DLG mode includes a gate driver that outputs gate signals to the gate lines. The configuration of the gate driver can vary, particularly in the number of gate clock signals it uses. As the number of gate clock signals increases, the amount of layout area – or dead space – occupied by the gate driver may also increase.

### SUMMARY

Embodiments of the present inventive concept provide a gate driver that can reduce a dead space of a display device supporting a Dual Line Gate (DLG) mode.

Embodiments of the present inventive concept provide an electronic device including the gate driver.

In an embodiment of a gate driver according to the present inventive concept, the gate driver includes a plurality of stages. Each of the stages comprises a CQ node charging circuit configured to provide a previous carry signal and a second high gate voltage to a CQ node in response to the previous carry signal, a first CQS node charging circuit configured to provide the second high gate voltage to a CQS node in response to the previous carry signal, a second CQS node charging circuit configured to provide a first high gate voltage to the CQS node in response to a voltage of a boosting node, a QB node control circuit configured to invert a voltage of the CQ node to provide the inverted voltage of the CQ node to a QB node, a CQ node boosting circuit configured to provide a boosting clock signal to the boosting node in response to the voltage of the CQ node, and to provide a second low gate voltage to the boosting node in response to a voltage of the QB node, and a gate output circuit configured to output first to P-th (wherein P is a positive integer greater than 2) gate clock signals as first to P-th gate signals in response to the voltage of the CQ node, and to output a first low gate voltage as the first to P-th gate signals in response to the voltage of the QB node. A pulse of each of the first to P-th gate signals is included in a duration in which the voltage of the boosting node has a high level, and the duration in which the voltage of the boosting node has the high level is included in a duration in which the voltage of the CQ node has the high level. The stages receive first to Q-th (wherein Q is a positive integer greater than P) gate clock signals. When a first stage is configured to output first to P-th gate clock signals as first to P-th gate signals, a second stage is configured to output P+1-th to Q-th gate clock signals as P+1-th to Q-th gate signals, and then the second stage is configured to output the first gate clock signal as Q+1-th gate signal, a duration in which the Q+1-th gate signal is output is separated from a duration in which a voltage of a CQ node of the first stage has the high level.

In an embodiment, Q may be a multiple of 2.

In an embodiment, Q may be a minimum value which satisfies a condition that the duration in which the second stage is configured to output the Q+1-th gate signal is separated from the duration in which the voltage of the CQ node of the first stage has the high level.

In an embodiment, the gate driver may be configured to support a Dual Line Gate (DLG) mode, and while the gate driver is configured to perform the DLG mode, a time length of a pulse of each of the first to Q-th gate clock signals may be reduced.

In an embodiment, P may be 6 and Q may be 10.

In an embodiment, the CQ node charging circuit may include a first-first transistor including a gate electrode that receives the previous carry signal, a first electrode that receives the previous carry signal, and a second electrode that receives the second high gate voltage, and a first-second transistor including a gate electrode that receives the previous carry signal, a first electrode that receives the second high gate voltage, and a second electrode connected to the CQ node.

In an embodiment, the first CQS node charging circuit may include a first transistor including a gate electrode that receives the previous carry signal, a first electrode that receives the second high gate voltage, and a second electrode connected to the CQS node. The second CQS node charging circuit may include a second transistor including a gate electrode that receives the voltage of the boosting node, a first electrode that receives the first high gate voltage, and a second electrode connected to the CQS node.

In an embodiment, the QB node control circuit may include a first transistor including a gate electrode that receives the first high gate voltage, a first electrode that receives the first high gate voltage, and a second electrode, a second transistor including a gate electrode connected to the second electrode of the first transistor, a first electrode that receives the first high gate voltage, and a second electrode connected to the QB node, a third transistor including a gate electrode connected to the CQ node, a first electrode that receives the first low gate voltage, and a second electrode connected to the second electrode of the first transistor and the gate electrode of the second transistor, and a fourth transistor including a gate electrode connected to the CQ node, a first electrode that receives the second low gate voltage, and a second electrode connected to the QB node.

In an embodiment, the CQ node boosting circuit may include a first transistor including a gate electrode connected to the CQ node, a first electrode that receives the boosting clock signal, and a second electrode connected to the boosting node, a second transistor including a gate electrode connected to the QB node, a first electrode that receives the second low gate voltage, and a second electrode connected to the boosting node, and a CQ boost capacitor including a first electrode connected to the CQ node and a second electrode connected to the boosting node.

In an embodiment, the gate output circuit may include first to P-th gate output circuits configured to output the first to P-th gate signals. The P-th gate output circuit may include a P-th gate variable on transistor including a gate electrode connected to the CQS node, a first electrode connected to the CQ node, and a second electrode connected to a P-th gate Q node, a first-P-th transistor including a gate electrode connected to the P-th gate Q node, a first electrode that receives the P-th gate clock signal, and a second electrode connected to a P-th gate node from which the P-th gate signal is output, a second-P-th transistor including a gate electrode connected to the QB node, a first electrode that receives the first low gate voltage, and a second electrode connected to the P-th gate node, and a P-th gate boost capacitor including a first electrode connected to the P-th gate Q node and a second electrode connected to the boosting node.

In an embodiment, each of the stages may further include a first CQ node discharging circuit configured to provide the second low gate voltage to the CQ node in response to a next carry signal, and a second CQ node discharging circuit configured to provide the second low gate voltage to the CQ node in response to the voltage of the QB node.

In an embodiment, the first CQ node discharging circuit may include a first transistor including a gate electrode that receives the next carry signal, a first electrode that receives the second low gate voltage, and a second electrode connected to the CQ node. The second CQ node discharging circuit may include a second transistor including a gate electrode connected to the QB node, a first electrode that receives the second low gate voltage, and a second electrode connected to the CQ node.

In an embodiment, each of the stages may further include a third CQS node charging circuit configured to provide the first high gate voltage to the CQS node in response to a next carry signal.

In an embodiment, the third CQS node charging circuit may include a first transistor including a gate electrode that receives the next carry signal, a first electrode that receives the first high gate voltage, and a second electrode connected to the CQS node.

In an embodiment, each of the stages may further include a CQS node discharging circuit configured to provide the first low gate voltage to the CQS node in response to the voltage of the QB node.

In an embodiment, the CQS node discharging circuit may include a first transistor including a gate electrode connected to the QB node, a first electrode that receives the first low gate voltage, and a second electrode connected to the CQS node.

In an embodiment, each of the stages may further include a carry output circuit configured to output a carry clock signal as the carry signal in response to the voltage of the CQ node and to output the second low gate voltage as the carry signal in response to the voltage of the QB node.

In an embodiment, the carry output circuit may include a carry variable on transistor including a gate electrode connected to the CQS node, a first electrode connected to the CQ node, and a second electrode connected to a carry Q node, a first transistor including a gate electrode connected to the carry Q node, a first electrode that receives the carry clock signal, and a second electrode connected to the carry node from which the carry signal is output, a second transistor including a gate electrode connected to the QB node, a first electrode that receives the second low gate voltage, and a second electrode connected to the carry node, and a carry boost capacitor including a first electrode connected to the carry Q node and a second electrode connected to the carry node.

In an embodiment of an electronic device according to the present inventive concept, the electronic device includes a display panel including a pixel, a data driver configured to provide a data voltage to the pixel, a gate driver configured to provide a gate signal to the pixel, a driving controller configured to control the data driver and the gate driver, and a power supply configured to provide a power to the display panel, the data driver, the gate driver, and the driving controller. The gate driver comprises a plurality of stages. Each of the stages includes a CQ node charging circuit configured to provide a previous carry signal and a second high gate voltage to a CQ node in response to the previous carry signal, a first CQS node charging circuit configured to provide the second high gate voltage to a CQS node in response to the previous carry signal, a second CQS node charging circuit configured to provide a first high gate voltage to the CQS node in response to a voltage of a boosting node, a QB node control circuit configured to invert a voltage of the CQ node to provide the inverted voltage of the CQ node to a QB node, a CQ node boosting circuit configured to provide a boosting clock signal to the boosting node in response to the voltage of the CQ node, and to provide a second low gate voltage to the boosting node in response to a voltage of the QB node, and a gate output circuit configured to output first to P-th (wherein P is a positive integer greater than 2) gate clock signals as first to P-th gate signals in response to the voltage of the CQ node, and to output a first low gate voltage as the first to P-th gate signals in response to the voltage of the QB node. A pulse of each of the first to P-th gate signals is included in a duration in which the voltage of the boosting node has a high level, and the duration in which the voltage of the boosting node has the high level is included in a duration in which the voltage of the CQ node has the high level. The stages receive first to Q-th (wherein Q is a positive integer greater than P) gate clock signals. When a first stage is configured to output first to P-th gate clock signals as first to P-th gate signals, a second stage is configured to output P+1-th to Q-th gate clock signals as P+1-th to Q-th gate signals, and then the second stage is configured to output the first gate clock signal as Q+1-th gate signal, a duration in which the Q+1-th gate signal is output is separated from a duration in which a voltage of a CQ node of the first stage has the high level.

In an embodiment, Q may be a multiple of 2.

According to the gate driver and the electronic device, Q may be a minimum value among Q values which satisfy a condition that a duration in which a Q+1-th gate signal of a second stage is output is separated from a duration in which a voltage of a CQ node of a first stage has a high level. Accordingly, a dead space of the gate driver may be reduced.

### BRIEF DESCRIPTION OF THE DRAWINGS

The above and other features of the present inventive concept will become more apparent by describing in detail embodiments thereof with reference to the accompanying drawings, in which:

FIG. 1 is a block diagram showing a display device according to embodiments of the present inventive concept;

FIG. 2 is a block diagram showing an example of a pixel of FIG. 1;

FIG. 3 is a block diagram showing a gate driver of FIG. 1;

FIG. 4 is a circuit diagram showing a stage of FIG. 3;

FIG. 5 is a timing diagram showing an operation of a stage of FIG. 4;

FIG. 6 is a circuit diagram showing an operation of a stage of FIG. 4 in a first duration of FIG. 5;

FIG. 7 is a circuit diagram showing an operation of a stage of FIG. 4 in a second duration of FIG. 5;

FIG. 8 is a circuit diagram showing an operation of a stage of FIG. 4 in a third duration of FIG. 5;

FIG. 9 is a circuit diagram showing an operation of a stage of FIG. 4 in a fourth duration of FIG. 5;

FIGS. 10 and 11 are conceptual diagrams explaining a number of clock signals;

FIG. 12 is a block diagram showing an electronic device; and

FIG. 13 is a diagram showing an embodiment in which an electronic device of FIG. 12 is implemented as a smartphone.

### DETAILED DESCRIPTION OF THE EMBODIMENTS

Embodiments of the present disclosure will be described more fully hereinafter with reference to the accompanying drawings. Like reference numerals may refer to like elements throughout the accompanying drawings.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

It will be understood that when a component is referred to as being “on”, “connected to”, “coupled to”, or “adjacent to” another component, it can be directly on, connected, coupled, or adjacent to the other component, or intervening components may be present. It will also be understood that when a component is referred to as being “between” two components, it can be the only component between the two components, or one or more intervening components may also be present. It will also be understood that when a component is referred to as “covering” another component, it can be the only component covering the other component, or one or more intervening components may also be covering the other component. Other words used to describe the relationships between components should be interpreted in a like fashion.

Embodiments of the present inventive concept relate to a gate driver architecture for a display device, which is capable of efficiently generating multiple gate signals using a reduced number of gate clock signals. For example, the gate driver may include a plurality of stages, each configured to output multiple gate signals while receiving a subset of shared gate clock signals. This configuration may support high-speed driving modes such as, for example, Dual Line Gate (DLG) mode, in which two adjacent gate lines are driven simultaneously to increase refresh rate, for example from about 60 Hz to about 120 Hz.

Each stage of the gate driver may include functionally distinct circuits, including, e.g., a CQ node charging circuit, CQS node charging circuits, a QB node control circuit, a CQ node boosting circuit, and a gate output circuit. These circuits may cooperate to enable the sequential generation of P gate signals (e.g., 6 signals) within timing windows that are synchronized with a boosting node and a CQ node. An aspect of embodiments of the inventive concept is the control of signal timing between stages to avoid interference. For example, the timing at which a subsequent stage outputs its (Q+1)-th gate signal is arranged so that it does not overlap with the period during which the CQ node of a preceding stage maintains a high voltage. This separation allows the number of gate clock signals (Q) to be reduced without compromising the stability or independence of the gate signals generated by each stage.

By improving the internal node timing and leveraging overlapping output windows across stages, embodiments of the present inventive concept may reduce the total number of gate clock signals required. This may minimize or reduce the dead space associated with signal routing and improve integration density, making the gate driver particularly suitable for high-resolution and high-speed display applications with stringent area constraints.

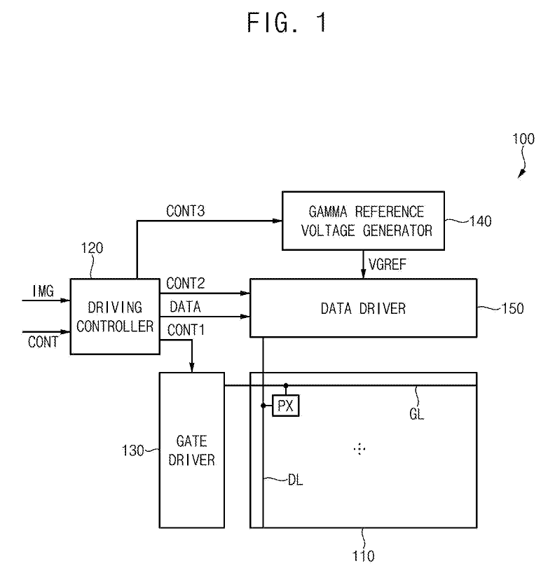

FIG. 1 is a block diagram showing a display device 100 according to embodiments of the present inventive concept.

Referring to FIG. 1, a display device 100 may include a display panel 110 and a display panel driver. The display panel driver may include a driving controller 120, a gate driver 130, a gamma reference voltage generator 140, and a data driver 150.

The display panel 110 may include a display area in which an image is displayed and a peripheral area disposed adjacent to the display area in which an image is not displayed The peripheral area may correspond to a bezel area.

The display panel 110 may include gate lines GL, data lines DL, emission lines EML, and pixels PX electrically connected to the gate lines GL, the data lines DL, and the emission lines EML, respectively. The gate lines GL may extend in a first direction, the data lines DL may extend in a second direction crossing the first direction, and the emission lines EML may extend in the first direction.

The driving controller 120 may receive input image data IMG and an input control signal CONT from an external device. For example, the input image data IMG may include red image data, green image data and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 120 may generate a first control signal CONT1, a second control signal CONT2, a third control signal CONT3, and a data signal DATA based on the input image data IMG and the input control signal CONT.

The driving controller 120 may generate the first control signal CONT1 that controls an operation of the gate driver 130 based on the input control signal CONT, and output the first control signal CONT1 to the gate driver 130. The first control signal CONT1 may include a vertical start signal and a gate clock signal.

The driving controller 120 may generate the second control signal CONT2 that controls an operation of the data driver 150 based on the input control signal CONT, and output the second control signal CONT2 to the data driver 150. The second control signal CONT2 may include a horizontal start signal and a load signal.

The driving controller 120 may generate the data signal DATA based on the input image data IMG. The driving controller 120 may output the data signal DATA to the data driver 150.

The driving controller 120 may generate the third control signal CONT3 that controls an operation of the gamma reference voltage generator 140 based on the input control signal CONT, and output the third control signal CONT3 to the gamma reference voltage generator 140.

The gate driver 130 may generate gate signals that drive the gate lines GL in response to the first control signal CONT1 received from the driving controller 120. The gate driver 130 may output the gate signals to the gate lines GL.

The gamma reference voltage generator 140 may generate a gamma reference voltage VGREF in response to the third control signal CONT3 received from the driving controller 120. The gamma reference voltage generator 140 may provide the gamma reference voltage VGREF to the data driver 150. The gamma reference voltage VGREF may have a value corresponding to each data signal DATA.

For example, the gamma reference voltage generator 140 may be disposed within the driving controller 120 or may be disposed within the data driver 150.

The data driver 150 may receive the second control signal CONT2 and the data signal DATA from the driving controller 120, and receive the gamma reference voltage VGREF from the gamma reference voltage generator 140. The data driver 150 may convert the data signal DATA into a data voltage having an analog type using the gamma reference voltage VGREF. The data driver 150 may output the data voltage to the data line DL.

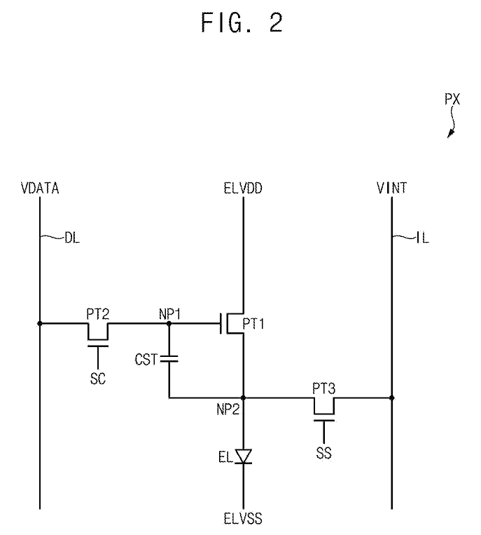

FIG. 2 is a block diagram showing an example of a pixel PX of FIG. 1.

Referring to FIGS. 1 and 2, a pixel PX may include a first pixel transistor PT1, a second pixel transistor PT2, a third pixel transistor PT3, a storage capacitor CST, and a light emitting element EL. In an embodiment, the first pixel transistor PT1, the second pixel transistor PT2, and the third pixel transistor PT3 may be NMOS transistors.

The first pixel transistor PT1 may include a gate electrode connected to a first pixel node NP1, a first electrode that receives a high power supply voltage ELVDD, and a second electrode connected to a second pixel node NP2. The second pixel transistor PT2 may include a gate electrode that receives a scan gate signal SC, a first electrode connected to a data line DL transmitting a data voltage VDATA, and a second electrode connected to the first pixel node NP1. The third pixel transistor PT3 may include a gate electrode that receives a sensing gate signal SS, a first electrode connected to an initialization line IL transmitting an initialization voltage VINT, and a second electrode connected to the second pixel node NP2. The storage capacitor CST may include a first electrode connected to the first pixel node NP1 and a second electrode connected to the second pixel node NP2. The light emitting element EL may include an anode electrode connected to the second pixel node NP2 and a cathode electrode that receives a low power supply voltage ELVSS lower than the high power supply voltage ELVDD.

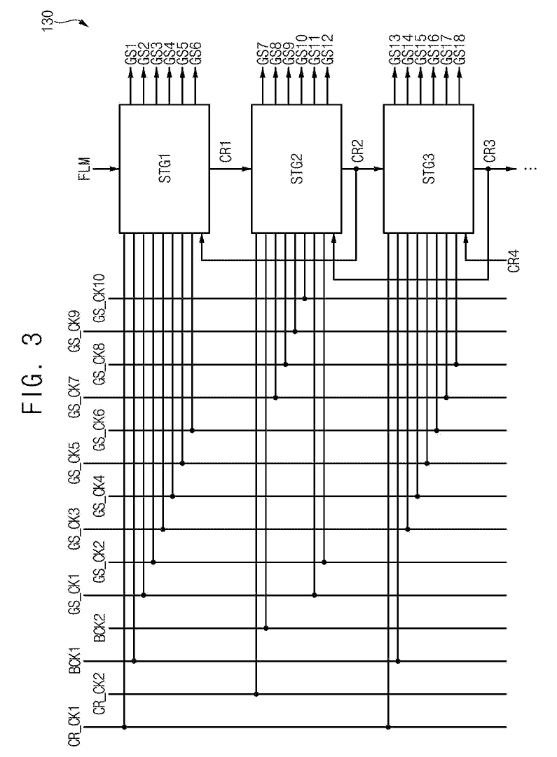

FIG. 3 is a block diagram showing a gate driver 130 of FIG. 1.

Referring to FIGS. 1 to 3, the gate driver 130 may include a plurality of stages STG1, STG2, STG3, .... The stages STG1, STG2, STG3, ... may output gate signals. Here, the gate signal may be the scan gate signal SC or the sensing gate signal SS of FIG. 2.

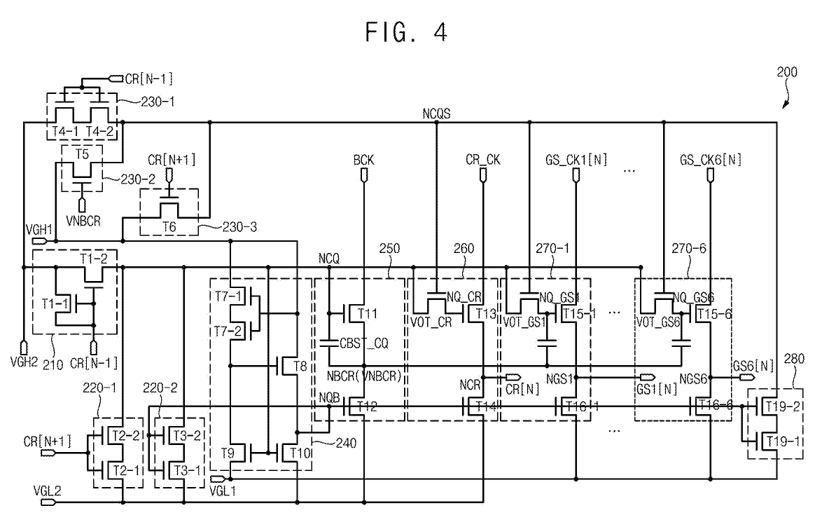

Each of the stages STG1, STG2, STG3, ... may output P gate signals based on P gate clock signals (where P is a positive integer greater than 2). The stages STG1, STG2, STG3, ... may receive first to Q-th (where Q is a positive integer greater than P) gate clock signals. As Q is large, a number of gate clock signals may increase, and a dead space of the gate driver 130 may increase. Therefore, it may be important to obtain a minimum value of Q. FIGS. 3 to 12 show a case where the minimum value of Q (e.g., 10) is obtained when P is 6. However, the gate driver 130 may support a DLG mode, and Q may be a multiple of 2. The DLG mode will be described later in FIG. 4.

The stages STG1, STG2, STG3, ... may receive first to second carry clock signals CR_CK1 to CR_CK2, first to second boosting clock signals BCK1 to BCK2, and first to tenth gate clock signals GS_CK1 to GS_CK10. For example, the first to second carry clock signals CR_CK1 to CR_CK2 may be clock signals having different phases. For example, the first to second boosting clock signals BCK1 to BCK2 may be clock signals having different phases. For example, the first to tenth gate clock signals GS_CK1 to GS_CK10 may be clock signals having different phases.

In addition, a first stage STG1 may further receive a gate start signal FLM and a second carry signal CR2. Each of subsequent stages STG1, STG2, STG3, ... may further receive a carry signal of a previous stage (e.g., a previous carry signal) and a carry signal of a next stage (e.g., a next carry signal). However, the present inventive concept is not limited thereto.

Each of the stages STG1, STG2, STG3, ... may sequentially output the gate signals GS1, GS2, GS3, GS4, GS5, GS6, GS7, GS8, GS9, GS10, GS11, GS12, GS13, GS14, GS15, GS16, GS17, GS18, .... In addition, each of the stages STG1, STG2, STG3, ... may sequentially output carry signals CR1, CR2, CR3, CR4, ....

For example, the first stage STG1 may receive the gate start signal FLM, the second carry signal CR2, the first carry clock signal CR_CK1, the first boosting clock signal BCK1, and the first to sixth gate clock signals GS_CK1 to GS_CK6. The first stage STG1 may sequentially output the first to sixth gate clock signals GS_CK1 to GS_CK6 as first to sixth gate signals GS1 to GS6. The first stage STG1 may output a first carry signal CR1.

For example, a second stage STG2 may receive the first carry signal CR1, the third carry signal CR3, the second carry clock signal CR_CK2, the second boosting clock signal BCK2, the seventh to tenth gate clock signals GS_CK7 to GS_CK10, and the first to second gate clock signals GS_CK1 to GS_CK2. The second stage STG2 may sequentially output the seventh to tenth gate clock signals GS_CK7 to GS_CK10 and the first to second gate clock signals GS_CK1 to GS_CK2 as seventh to twelfth gate signals GS7 to GS12. The second stage STG2 may output the second carry signal CR2.

For example, the third stage STG3 may receive the second carry signal CR2, the fourth carry signal CR4, the first carry clock signal CR_CK1, the first boosting clock signal BCK1, and the third to eighth gate clock signals GS_CK3 to GS_CK8. The third stage STG3 may sequentially output the third to eighth gate clock signals GS_CK3 to GS_CK8 as thirteenth to eighteenth gate signals GS13 to GS18. The third stage STG3 may output a third carry signal CR3.

FIG. 4 is a circuit diagram showing a stage 200 of FIG. 3.

Referring to FIGS. 1 to 4, the gate driver 130 may include a plurality of stages 200. A stage 200 of FIG. 4 may be an N-th stage of FIG. 3 (where N is a positive integer greater than or equal to 1). The gate driver 130 may support a DLG (Dual Line Gate) mode. The DLG mode refers to a mode which uses a method of simultaneously driving two consecutive gate lines to increase a driving frequency of the display device 100. When the gate driver 130 performs the DLG mode, a time length of a pulse of a gate signal may be reduced in order to simultaneously drive two consecutive gate lines.

Each stage 200 may be configured as follows. In an embodiment, a gate driver may include a plurality of stages, each including several functional circuits. Each stage 200 may include a CQ node charging circuit configured to supply a previous carry signal and a second high gate voltage to a CQ node in response to the previous carry signal. A first CQS node charging circuit may be configured to provide the second high gate voltage to a CQS node in response to the previous carry signal, and a second CQS node charging circuit may be configured to provide a first high gate voltage to the CQS node in response to a voltage of a boosting node. A QB node control circuit may invert the voltage of the CQ node and provide the inverted voltage to a QB node. A CQ node boosting circuit may be configured to provide a boosting clock signal to the boosting node based on the voltage of the CQ node and to apply a second low gate voltage to the boosting node based on the voltage of the QB node. Additionally, a gate output circuit may output first through P-th (where P is a positive integer greater than 2) gate clock signals as first through P-th gate signals in response to the voltage of the CQ node, and output a first low gate voltage as the first through P-th gate signals in response to the voltage of the QB node. A pulse of each of the first through P-th gate signals occurs during a period in which the boosting node has a high-level voltage, and this period is included within the high-level period of the CQ node. The stages receive first through Q-th (where Q is a positive integer greater than P) gate clock signals. When a first stage outputs the first through P-th gate signals, a second stage outputs the P+1-th through Q-th gate signals, and then outputs the Q+1-th gate signal using the first gate clock signal. The output timing of the Q+1-th gate signal is separated from the high-level period of the CQ node in the first stage, thereby preventing overlap and enabling a minimized value of Q.

The stage 200 may include a CQ node charging circuit 210, a first CQ node discharging circuit 220-1, a second CQ node discharging circuit 220-2, a first CQS node charging circuit 230-1, a second CQS node charging circuit 230-2, a third CQS node charging circuit 230-3, a QB node control circuit 240, a CQ node boosting circuit 250, a carry output circuit 260, a gate output circuit, and a CQS node discharging circuit 280. In an embodiment, transistors included in the stage 200 may be NMOS transistors. However, the present inventive concept is not limited thereto.

The CQ node charging circuit 210 may provide the previous carry signal CR[N-1] and the second high gate voltage VGH2 to the CQ node NCQ in response to a previous carry signal CR[N-1].

The CQ node charging circuit 210 may include a first-first transistor T1-1 and a first-second transistor T1-2. The first-first transistor T1-1 may include a gate electrode that receives the previous carry signal CR[N-1], a first electrode that receives the previous carry signal CR[N-1], and a second electrode that receives a second high gate voltage VGH2. The first-second transistor T1-2 may include a gate electrode that receives the previous carry signal CR[N-1], a first electrode that receives the second high gate voltage VGH2, and a second electrode connected to the CQ node NCQ.

The first CQ node discharging circuit 220-1 may provide a second low gate voltage VGL2 to the CQ node NCQ in response to a next carry signal CR[N+1].

The first CQ node discharging circuit 220-1 may include a second transistor T2-1, T2-2. The second transistor T2-1, T2-2 may include a gate electrode that receives the next carry signal CR[N+1], a first electrode that receives the second low gate voltage VGL2, and a second electrode connected to the CQ node NCQ. In an embodiment, the second transistor T2-1, T2-2 may include a second-first transistor T2-1 and a second-second transistor T2-2 which are connected in series and whose gate electrodes are connected to each other.

The second CQ node discharging circuit 220-2 may provide the second low gate voltage VGL2 to the CQ node NCQ in response to a voltage of a QB node NQB.

The second CQ node discharging circuit 220-2 may include a third transistor T3-1, T3-2. The third transistor T3-1, T3-2 may include a gate electrode connected to the QB node NQB, a first electrode that receives the second low gate voltage VGL2, and a second electrode connected to the CQ node NCQ. In an embodiment, the third transistor T3-1, T3-2 may include a third-first transistor T3-1 and a third-second transistor T3-2 which are connected in series and whose gate electrodes are connected to each other.

As used herein, a CQ node may refer to a node in a gate driver stage that receives and stores a voltage in response to a previous carry signal and is used to control generation of gate signals, a CQS node may refer to a control node in the gate output circuit that receives a high voltage in response to a carry signal or a boosting node voltage and gates transistors that transfer the CQ node voltage to gate output nodes, and a QB node may refer to a node that holds an inverted voltage based on the CQ node, and is used to discharge the CQ node, CQS node, and related nodes and circuits.

The first CQS node charging circuit 230-1 may provide the second high gate voltage VGH2 to the CQS node NCQS in response to the previous carry signal CR[N-1].

The first CQS node charging circuit 230-1 may include a fourth transistor T4-1, T4-2. The fourth transistor T4-1, T4-2 may include a gate electrode that receives the previous carry signal CR[N-1], a first electrode that receives the second high gate voltage VGH2, and a second electrode connected to the CQS node NCQS. In an embodiment, the fourth transistor T4-1, T4-2 may include a fourth-first transistor T4-1 and a fourth-second transistor T4-2 which are connected in series and whose gate electrodes are connected to each other.

The second CQS node charging circuit 230-2 may provide a first high gate voltage VGL1 to the CQS node NCQS in response to a voltage VNBCR of a boosting node NBCR.

The second CQS node charging circuit 230-2 may include a fifth transistor T5. The fifth transistor T5 may include a gate electrode that receives the voltage VNBCR of the boosting node NBCR, a first electrode that receives the first high gate voltage VGH1, and a second electrode connected to the CQS node NCQS.

The third CQS node charging circuit 230-3 may provide the first high gate voltage VGH1 to the CQS node NCQS in response to the next carry signal CR[N+1].

The third CQS node charging circuit 230-3 may include a sixth transistor T6. The sixth transistor T6 may include a gate electrode that receives the next carry signal CR[N+1], a first electrode that receives the first high gate voltage VGH1, and a second electrode connected to the CQS node NCQS.

The QB node control circuit 240 may invert a voltage of the CQ node NCQ and provide the inverted voltage of the CQ node NCQ to the QB node NQB.

The QB node control circuit 240 may include a seventh transistor T7-1, T7-2, an eighth transistor T8, a ninth transistor T9, and a tenth transistor T10. The seventh transistor T7-1, T7-2 may include a gate electrode that receives the first high gate voltage VGH1, a first electrode that receives the first high gate voltage VGH1, and a second electrode. In an embodiment, the seventh transistor T7-1, T7-2 may include a seventh-first transistor T7-1 and a seventh-second transistor T7-2 which are connected in series and whose gate electrodes are connected to each other. The eighth transistor T8 may include a gate electrode connected to the second electrode of the seventh transistor T7-1, T7-2, a first electrode that receives the first high gate voltage VGH1, and a second electrode connected to the QB node NQB. The ninth transistor T9 may include a gate electrode connected to the CQ node NCQ, a first electrode that receives the first low gate voltage VGL1, and a second electrode connected to the second electrode of the seventh transistor T7-1, T7-2 and the gate electrode of the eighth transistor T8. The tenth transistor T10 may include a gate electrode connected to the CQ node NCQ, a first electrode that receives the second low gate voltage VGL2, and a second electrode connected to the QB node NQB.

The CQ node boosting circuit 250 may provide a boosting clock signal BCK to the boosting node NBCR in response to the voltage of the CQ node NCQ, and may provide the second low gate voltage VGL2 to the boosting node NBCR in response to the voltage of the QB node NQB.

The CQ node boosting circuit 250 may include an eleventh transistor T11, a twelfth transistor T12, and a CQ boost capacitor CBST_CQ. The eleventh transistor T11 may include a gate electrode connected to the CQ node NCQ, a first electrode that receives the boosting clock signal BCK, and a second electrode connected to the boosting node NBCR. The twelfth transistor T12 may include a gate electrode connected to the QB node NQB, a first electrode that receives the second low gate voltage VGL2, and a second electrode connected to the boosting node NBCR. The CQ boost capacitor CBST_CQ may include a first electrode connected to the CQ node NCQ and a second electrode connected to the boosting node NBCR.

The carry output circuit 260 may output a carry clock signal CR_CK as a carry signal CR[N] in response to the voltage of the CQ node NCQ, and may output the second low gate voltage VGL2 as the carry signal CR[N] in response to the voltage of the QB node NQB.

The carry output circuit 260 may include a carry variable on transistor VOT_CR, a thirteenth transistor T13, and a fourteenth transistor T14. The carry variable on transistor VOT_CR may include a gate electrode connected to the CQS node NCQS, a first electrode connected to the CQ node NCQ, and a second electrode connected to a carry Q node NQ_CR. The thirteenth transistor T13 may include a gate electrode connected to the carry Q node NQ_CR, a first electrode that receives the carry clock signal CR_CK, and a second electrode connected to a carry node NCR from which the carry signal CR[N] is output. The fourteenth transistor T14 may include a gate electrode connected to the QB node NQB, a first electrode that receives the second low gate voltage VGL2, and a second electrode connected to the carry node NCR.

The gate output circuit may include first to P-th gate output circuits which output the first to P gate signals.

The P-th gate output circuit may include a P-th gate variable on transistor, a fifteenth-P-th transistor, a sixteenth-P-th transistor, and a P-th gate boost capacitor. The P-th gate variable on transistor may include a gate electrode connected to the CQS node NCQS, a first electrode connected to the CQ node NCQ, and a second electrode connected to a P-th gate Q node. The fifteenth-P-th transistor may include a gate electrode connected to the P-th gate Q node, a first electrode that receives the P-th gate clock signal, and a second electrode connected to a P-th gate node from which the P gate signal is output. The sixteenth-P-th transistor may include a gate electrode connected to the QB node NQB, a first electrode that receives the first low gate voltage VGL1, and a second electrode connected to the P-th gate node. The P-th gate boost capacitor may include a first electrode connected to the P-th gate Q node and a second electrode connected to the boosting node NBCR.

In an embodiment, P may be 6. Therefore, the gate output circuit may include first to sixth gate output circuits 270-1 to 270-6 which output the first to sixth gate signals GS1[N], ..., GS6[N].

For example, the first gate output circuit 270-1 may output a first gate clock signal GS_CK1[N] as a first gate signal GS1[N] in response to the voltage of the CQ node NCQ, and may output the first low gate voltage VGL1 as the first gate signal GS1[N] in response to the voltage of the QB node NQB.

The first gate output circuit 270-1 may include a first gate variable on transistor VOT_GS1, a fifteenth-first transistor T15-1, a sixteenth-first transistor T16-1, and a first gate boost capacitor CBST_GS1. The first gate variable on transistor VOT_GS1 may include a gate electrode connected to the CQS node NCQS, a first electrode connected to the CQ node NCQ, and a second electrode connected to a first gate Q node NQ_GS1. The fifteenth-first transistor T15-1 may include a gate electrode connected to the first gate Q node NQ_GS1, a first electrode that receives the first gate clock signal GS_CK1[N], and a second electrode connected to a first gate node NGS1 from which the first gate signal GS1[N] is output. The sixteenth-first transistor T16-1 may include a gate electrode connected to the QB node NQB, a first electrode that receives the first low gate voltage VGL1, and a second electrode connected to the first gate node NGS1. The first gate boost capacitor CBST_GS1 may include a first electrode connected to the first gate Q node NQ_GS1 and a second electrode connected to the boosting node NBCR.

For example, the second gate output circuit may output a second gate clock signal GS_CK2[N] as a second gate signal in response to the voltage of the CQ node NCQ, and may output the first low gate voltage VGL1 as the second gate signal in response to the voltage of the QB node NQB.

The second gate output circuit may include a second gate variable on transistor, a fifteenth-second transistor, a sixteenth-second transistor, and a second gate boost capacitor. The second gate variable on transistor may include a gate electrode connected to the CQS node NCQS, a first electrode connected to the CQ node NCQ, and a second electrode connected to a second gate Q node. The fifteenth-second transistor may include a gate electrode connected to the second gate Q node, a first electrode that receives the second gate clock signal GS_CK2[N], and a second electrode connected to a second gate node from which the second gate signal is output. The sixteenth-second transistor may include a gate electrode connected to the QB node NQB, a first electrode that receives the first low gate voltage VGL1, and a second electrode connected to the second gate node. The second gate boost capacitor may include a first electrode connected to the second gate Q node and a second electrode connected to the boosting node NBCR.

For example, the third gate output circuit may output a third gate clock signal GS_CK3[N] as a third gate signal in response to the voltage of the CQ node NCQ, and may output the first low gate voltage VGL1 as the third gate signal in response to the voltage of the QB node NQB.

The third gate output circuit may include a third gate variable on transistor, a fifteenth-third transistor, a sixteenth-third transistor, and a third gate boost capacitor. The third gate variable on transistor may include a gate electrode connected to the CQS node NCQS, a first electrode connected to the CQ node NCQ, and a second electrode connected to the third gate Q node. The fifteenth-third transistor may include a gate electrode connected to the third gate Q node, a first electrode that receives the third gate clock signal GS_CK3[N], and a second electrode connected to a third gate node from which the third gate signal is output. The sixteenth-third transistor may include a gate electrode connected to the QB node NQB, a first electrode that receives the first low gate voltage VGL1, and a second electrode connected to the third gate node. The third gate boost capacitor may include a first electrode connected to the third gate Q node and a second electrode connected to the boosting node NBCR.

For example, the fourth gate output circuit may output a fourth gate clock signal GS_CK4[N] as a fourth gate signal in response to the voltage of the CQ node NCQ, and may output the first low gate voltage VGL1 as the fourth gate signal in response to the voltage of the QB node NQB.

The fourth gate output circuit may include a fourth gate variable on transistor, a fifteenth-fourth transistor, a sixteenth-fourth transistor, and a fourth gate boost capacitor. The fourth gate variable on transistor may include a gate electrode connected to the CQS node NCQS, a first electrode connected to the CQ node NCQ, and a second electrode connected to a fourth gate Q node. The fifteenth-fourth transistor may include a gate electrode connected to the fourth gate Q node, a first electrode that receives the fourth gate clock signal GS_CK4[N], and a second electrode connected to a fourth gate node from which the fourth gate signal is output. The sixteenth-fourth transistor may include a gate electrode connected to the QB node NQB, a first electrode that receives the first low gate voltage VGL1, and a second electrode connected to the fourth gate node. The fourth gate boost capacitor may include a first electrode connected to the fourth gate Q node and a second electrode connected to the boosting node NBCR.

For example, the fifth gate output circuit may output a fifth gate clock signal GS_CK5[N] as a fifth gate signal in response to the voltage of the CQ node NCQ, and may output the first low gate voltage VGL1 as the fifth gate signal in response to the voltage of the QB node NQB.

The fifth gate output circuit may include a fifth gate variable on transistor, a fifteenth-fifth transistor, a sixteenth-fifth transistor, and a fifth gate boost capacitor. The fifth gate variable on transistor may include a gate electrode connected to the CQS node NCQS, a first electrode connected to the CQ node NCQ, and a second electrode connected to the fifth gate Q node. The fifteenth-fifth transistor may include a gate electrode connected to the fifth gate Q node, a first electrode that receives the fifth gate clock signal GS_CK5[N], and a second electrode connected to the fifth gate node from which the fifth gate signal is output. The sixteenth-fifth transistor may include a gate electrode connected to the QB node NQB, a first electrode that receives the first low gate voltage VGL1, and a second electrode connected to the fifth gate node. The fifth gate boost capacitor may include a first electrode connected to the fourth gate Q node and a second electrode connected to the boosting node NBCR.

For example, the sixth gate output circuit 270-6 may output a sixth gate clock signal GS_CK6[N] as a sixth gate signal GS6[N] in response to the voltage of the CQ node NCQ, and may output the first low gate voltage VGL1 as the sixth gate signal GS6[N] in response to the voltage of the QB node NQB.

The sixth gate output circuit 270-6 may include a sixth gate variable on transistor VOT_GS6, a fifteenth-sixth transistor T15-6, a sixteenth-sixth transistor T16-6, and a sixth gate boost capacitor CBST_GS6. The sixth gate variable on transistor VOT_GS6 may include a gate electrode connected to the CQS node NCQS, a first electrode connected to the CQ node NCQ, and a second electrode connected to a sixth gate Q node NQ_GS6. The fifteenth-sixth transistor T15-6 may include a gate electrode connected to the sixth gate Q node NQ_GS6, a first electrode that receives the sixth gate clock signal GS_CK6[N], and a second electrode connected to a sixth gate node NGS6 from which the sixth gate signal GS6[N] is output. The sixteenth-sixth transistor T16-6 may include a gate electrode connected to the QB node NQB, a first electrode that receives the first low gate voltage VGL1, and a second electrode connected to the sixth gate node NGS6. The sixth gate boost capacitor CBST_GS6 may include a first electrode connected to the sixth gate Q node NQ_GS6 and a second electrode connected to the boosting node NBCR.

The CQS node discharging circuit 280 may provide the first low gate voltage VGL1 to the CQS node NCQS in response to the voltage of the QB node NQB.

The CQS node discharging circuit 280 may include a nineteenth transistor T19-1, T19-2. The nineteenth transistor T19-1, T19-2 may include a gate electrode connected to the QB node NQB, a first electrode that receives the first low gate voltage VGL1, and a second electrode connected to the CQS node NCQS. In an embodiment, the nineteenth transistor T19-1, T19-2 may include a nineteenth-first transistor T19-1 and a nineteenth-second transistor T19-2 which are connected in series and whose gate electrodes are connected to each other.

For example, the second low gate voltage VGL2 may be about -10 V, the first low gate voltage VGL1 may be about -5 V, the first high gate voltage VGH1 may be about 15 V, and the second high gate voltage VGH2 may be about 25 V. A low level may include the second low gate voltage VGL2 and the first low gate voltage VGL1. A high level may include the first high gate voltage VGH1 and the second high gate voltage VGH2.

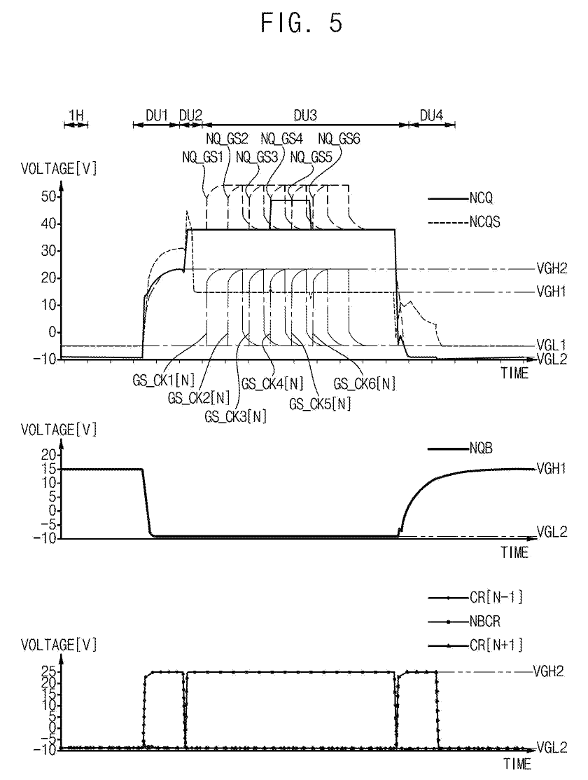

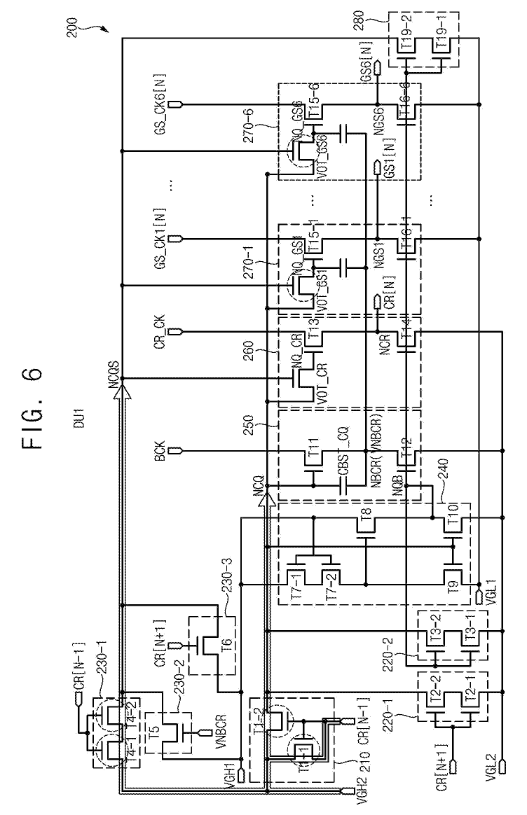

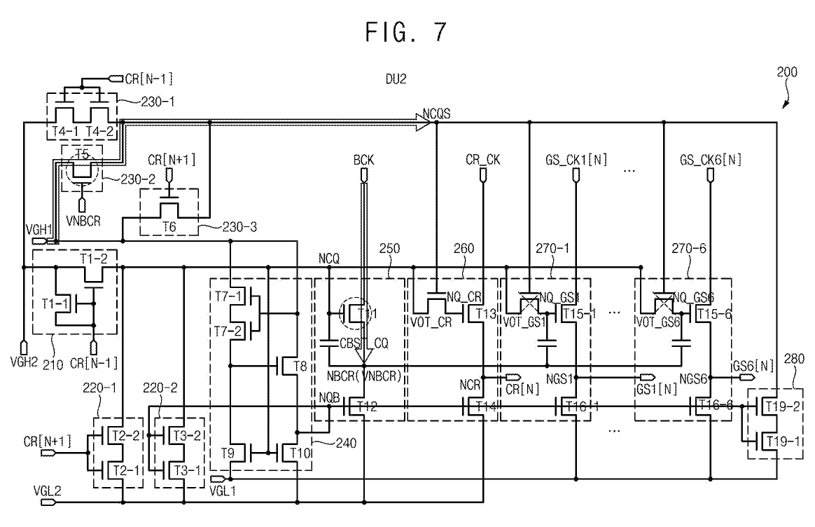

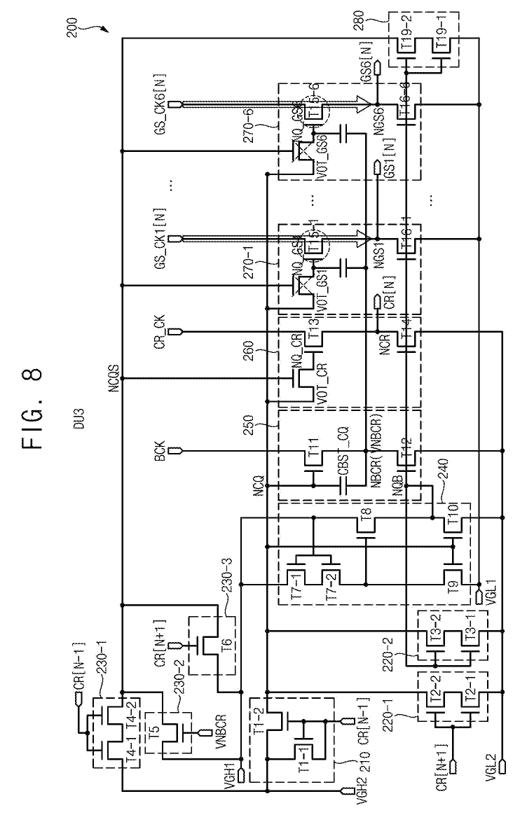

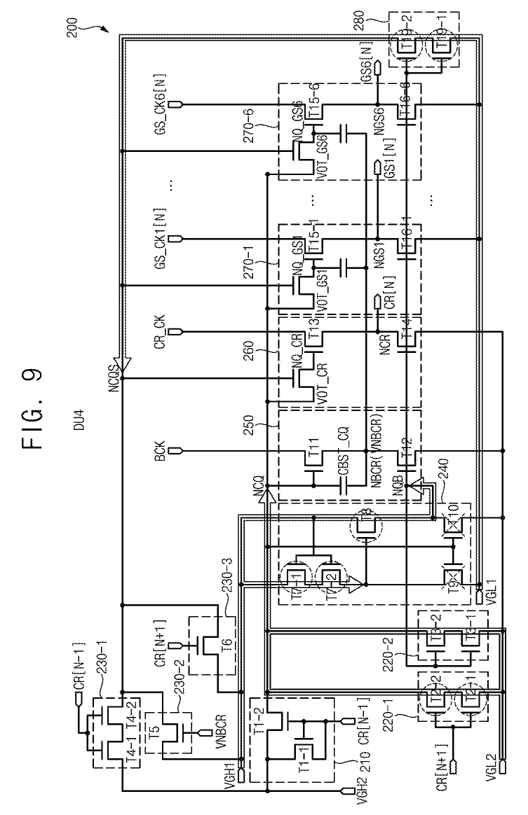

FIG. 5 is a timing diagram showing an operation of a stage 200 of FIG. 4. FIG. 6 is a circuit diagram showing an operation of a stage 200 of FIG. 4 in a first duration DU1 of FIG. 5. FIG. 7 is a circuit diagram showing an operation of a stage 200 of FIG. 4 in a second duration DU2 of FIG. 5. FIG. 8 is a circuit diagram showing an operation of a stage 200 of FIG. 4 in a third duration DU3 of FIG. 5. FIG. 9 is a circuit diagram showing an operation of a stage 200 of FIG. 4 in a fourth duration DU4 of FIG. 5.

Referring to FIGS. 5 and 6, in a first duration DU1, the previous carry signal CR[N-1] may have the second high gate voltage VGH2.

The first-first transistor T1-1 and the first-second transistor T1-2 may be turned on in response to the previous carry signal CR[N-1] having the second high gate voltage VGH2. The previous carry signal CR[N-1] having the second high gate voltage VGH2 may be provided to the CQ node NCQ through the first-first transistor T1-1 and the first-second transistor T1-2. The second high gate voltage VGH2 may be provided to the CQ node NCQ through the first-second transistor T1-2. Therefore, the voltage of the CQ node NCQ may have the second high gate voltage VGH2.

The fourth transistor T4-1, T4-2 may be turned on in response to the previous carry signal CR[N-1] having the second high gate voltage VGH2 to provide the second high gate voltage VGH2 to the CQS node NCQS. The first to sixth gate variable on transistors VOT_GS1 to VOT_GS6 may have a large size, and parasitic capacitances may be formed between the gate electrodes and the first electrodes. Due to an influence of the parasitic capacitances, the voltage of the CQS node NCQS may be higher than the second high gate voltage VGH2. For example, the voltage of the CQS node NCQS may be 30 V.

The first to sixth gate variable on transistors VOT_GS1 to VOT_GS6 may be turned on in response to the voltage of the CQ node NCQ and the voltage of the CQS node NCQS. Therefore, the first to sixth gate variable on transistors VOT_GS1 to VOT_GS6 may provide the voltage of the CQ node NCQ to the first to sixth gate Q nodes NQ_GS1 to NQ_GS6.

Referring to FIG. 5 and FIG. 7, in a second duration DU2, the eleventh transistor T11 may be turned on in response to the voltage of the CQ node NCQ having the second high gate voltage VGH2 to provide the boosting clock signal BCK to the boosting node NBCR. Due to this, the voltage VNBCR of the boosting node NBCR may be changed from the second low gate voltage VGL2 to the second high gate voltage VGH2.

When the voltage VNBCR of the boosting node NBCR is changed, the voltage of the CQ node NCQ may be bootstrapped by the CQ boost capacitor CBST_CQ. The voltage of the CQS node NCQS may be bootstrapped by the parasitic capacitances of the first to sixth gate variable on transistors VOT_GS1 to VOT_GS6. The voltages of the first to sixth gate Q nodes NQ_GS1 to NQ_GS6 may be bootstrapped by the first to sixth gate boost capacitances CBST_GS1 to GBST_GS6.

The fifth transistor T5 may be turned on in response to the voltage VNBCR of the boosting node NBCR to provide the first high gate voltage VGH1 to the CQS node NCQS. Therefore, the voltage of the CQS node NCQS may have the first high gate voltage VGH1.

The first to sixth gate variable on transistors VOT_GS1 to VOT_GS6 may be turned off in response to the voltage of the CQ node NCQ and the voltage of the CQS node NCQS.

Referring to FIGS. 5 and 8, in a third duration DU3, each of the fifteenth-first to fifteenth-sixth transistors T15-1 to T15-6 may be turned on to provide each of the first to sixth gate clock signals GS_CK1[N] to GS_CK6[N] to the first to sixth gate nodes NGS1 to NGS6. Therefore, the first to sixth gate signals GS1[N] to GS6[N] may be sequentially output.

The fifteenth-first to fifteenth-sixth transistors T15-1 to T15-6 may have a large size, and parasitic capacitances may be formed between the gate electrodes and the first electrodes. The first to sixth gate clock signals GS_CK1, ..., GS_CK6 may be changed from the first low gate voltage VGL1 to the second high gate voltage VGH2.

When the first to sixth gate clock signals GS_CK1, ..., GS_CK6 are changed, the voltages of the first to sixth gate Q nodes NQ_GS1, ..., NQ_GS6 may be bootstrapped by the parasitic capacitances. Therefore, the fifteenth-first to fifteenth-sixth transistors T15-1, ..., T15-6 may be sufficiently turned on. In this case, since the voltages of the first to sixth gate Q nodes NQ_GS1, ..., NQ_GS6 are bootstrapped in a duration in which the voltage VNBCR of the boosting node NBCR has the high level, a pulse of each of the first to sixth gate signals GS1[N], ..., GS6[N] may be included in the duration in which the voltage VNBCR of the boosting node NBCR has the high level. In addition, the duration in which the voltage VNBCR of the boosting node NBCR has the high level may be included in a duration in which the voltage of the CQ node NCQ has the high level.

Referring to FIGS. 5 and 9, in a fourth duration DU4, the next carry signal CR[N+1] may have the second high gate voltage VGH2.

The second transistors T2-1, T2-2 may be turned on in response to the next carry signal CR[N+1] having the second high gate voltage VGH2 to provide the second low gate voltage VGL2 to the CQ node NCQ. Therefore, the voltage of the CQ node NCQ may have the second low gate voltage VGL2.

The ninth transistor T9 and the tenth transistor T10 may be turned off in response to the voltage of the CQ node NCQ having the second low gate voltage VGL2. The seventh-first transistor T7-1 and the seventh-second transistor T7-2 may be turned on in response to the first high gate voltage VGH1 to provide the first high gate voltage VGH1 to the gate electrode of the eighth transistor T8. Therefore, the voltage of the gate electrode of the eighth transistor T8 may have the first high gate voltage VGH1, the eighth transistor T8 may be turned on, and the eighth transistor T8 may provide the first high gate voltage VGH1 to the QB node NQB. Therefore, the voltage of the QB node NQB may have the first high gate voltage VGH1.

The nineteenth transistor T19-1, T19-2 may be turned on in response to the voltage of the QB node NQB having the first high gate voltage VGH1 to provide the first low gate voltage VGL1 to the CQS node NCQS. Therefore, the voltage of the CQS node NCQS may have the first low gate voltage VGL1.

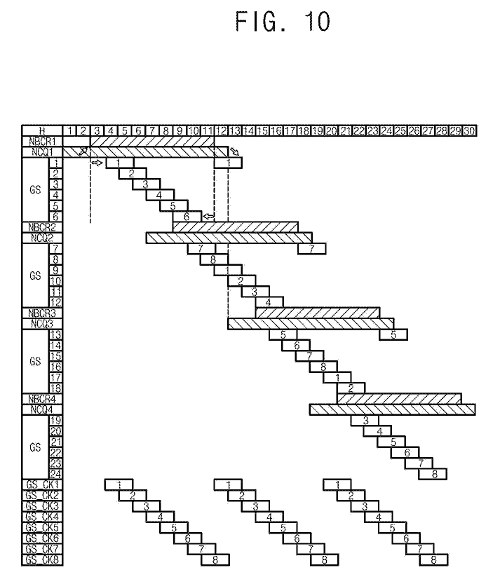

FIGS. 10 and 11 are conceptual diagrams explaining a number of clock signals.

Referring to FIGS. 1 to 11, P may be 6. That is, one stage may output six gate signals using six gate clock signals. However, the stages collectively may utilize more than six gate clock signals to operate properly. For example, the total number of gate clock signals used across all stages may be twice the number of gate signals output by a single stage. For example, when the one stage uses 6 gate clock signals, the total number of gate clock signals across the stages may be 12. In this case, a dead space of the gate driver 130 may increase.

To address this, consecutive gate signals may overlap each other. This configuration may enable a reduction in the total number of gate clock signals used across the stages. In this context, it may become beneficial to reduce the total number of gate clock signals as much as possible. That is, obtaining a minimum value of Q may allow for a more compact gate driver design.

For example, P may be 6, and Q may be 8. A pulse of each of first to sixth gate signals GS1[N], ..., GS6[N] of the stage 200 may be included in a duration in which a voltage VNBCR of a boosting node NBCR has a high level. In addition, a duration in which the voltage VNBCR of the boosting node NBCR has the high level may be included in a duration in which the voltage of the CQ node NCQ has the high level.

For example, in a first stage STG1, a voltage of a CQ node NCQ1 may have the high level in first to twelfth horizontal times H1 to H12. A voltage of a boosting node NBCR1 may have the high level in the third to eleventh horizontal times H3 to H11. First to sixth gate signals GS1 to GS6 may be sequentially output in the fourth to tenth horizontal times H4 to H10.

For example, in a second stage, a voltage of a CQ node NCQ2 may have the high level in seventh to eighteenth horizontal times H7 to H18. A voltage of a boosting node NBCR2 may have the high level in the ninth to seventeenth horizontal times H9 to H17. Seventh to twelfth gate signals GS7 to GS12 may be sequentially output in the tenth to sixteenth horizontal times H10 to H16.

For example, in a third stage, a voltage of a CQ node NCQ3 may have the high level at the 13th to 24th horizontal times H13 to H24. A voltage of a boosting node NBCR3 may have the high level in the fifteenth to twenty-third horizontal times H15 to H23. Thirteenth to eighteenth gate signals GS13 to GS18 may be sequentially output in the sixteenth to twenty-second horizontal times H16 to H22.

For example, in a fourth stage, a voltage of a CQ node NCQ4 may have the high level at the nineteenth to thirtieth horizontal times H19 to H30. A voltage of a boosting node NBCR4 may have the high level in the twenty-first to twenty-ninth horizontal times H21 to H29. Nineteenth to twenty-fourth gate signals GS19 to GS24 may be sequentially output in the twenty-second to twenty-eighth horizontal times H22 to H28.

A gate driver 130 may sequentially output gate signals in a frame duration. However, in order for the gate driver 130 to operate normally, a gate signal which has already been output should not be output again.

For example, the first gate signal GS1 was output based on the first gate clock signal GS_CK1 in the fourth to fifth horizontal times H4 to H5. However, when the ninth gate signal GS9 is output based on the first gate clock signal GS_CK1 in the twelfth to thirteenth horizontal times H12 to H13, the voltage of the CQ node NCQ1 of the first stage may still have the high level. Therefore, the first gate signal GS1 may also be output in the twelfth to thirteenth horizontal times H12 to H13. This problem may also occur in the seventh gate signal GS7, the thirteenth gate signal GS13, etc.

Referring to FIGS. 1 to 9 and FIG. 11, P may be 6, and Q may be 10.

For example, in a first stage STG1, a voltage of a CQ node NCQ1 may have the high level in first to twelfth horizontal times H1 to H12. A voltage of a boosting node NBCR1 may have the high level at the third to eleventh horizontal times H3 to H11. First to sixth gate signals GS1 to GS6 may be sequentially output in the fourth to tenth horizontal times H4 to H10.

For example, in a second stage, a voltage of a CQ node NCQ2 may have the high level in seventh to eighteenth horizontal times H7 to H18. A voltage of a boosting node NBCR2 may have the high level in the ninth to seventeenth horizontal times H9 to H17. Seventh to twelfth gate signals GS7 to GS12 may be sequentially output in the tenth to sixteenth horizontal times H10 to H16.

For example, in a third stage, a voltage of a CQ node NCQ3 may have the high level in thirteenth to twenty-fourth horizontal times H13 to H24. A voltage of a boosting node NBCR3 may have the high level in the fifteenth to twenty-third horizontal times H15 to H23. Thirteenth to eighteenth gate signals GS13 to GS18 may be sequentially output in the sixteenth to twenty-second horizontal times H16 to H22.

For example, in a fourth stage, a voltage of a CQ node NCQ4 may have the high level in nineteenth to twenty-ninth horizontal times H19 to H29. A voltage of a boosting node NBCR4 may have the high level in the twenty-first to thirtieth horizontal times H21 to H30. Nineteenth to twenty-fourth gate signals GS19 to GS24 may be sequentially output in the twenty-second to twenty-eighth horizontal times H22 to H28.

For example, in a fifth stage, a voltage of a CQ node NCQ5 may have the high level in twenty fifth to thirty sixth horizontal times H25 to H36. A voltage of a boosting node NBCR5 may have the high level in the twenty seventh to thirty fifth horizontal times H27 to H35. Twenty seventh to thirtieth gate signals GS25 to GS30 may be sequentially output in the twenty-eighth to thirty fourth horizontal times H28 to H34.

A gate driver 130 may sequentially output gate signals in a frame duration. However, in order for the gate driver 130 to operate normally, a gate signal which has already been output should not be output again.

For example, the first gate signal GS1 is output based on a first gate clock signal GS_CK1 in the fourth to fifth horizontal times H4 to H5. When the ninth gate signal GS9 is output based on the ninth gate clock signal GS_CK9 in the twelfth to thirteenth horizontal times H12 to H13, the voltage of the CQ node NCQ1 of the first stage may still have the high level. However, since the first stage does not receive the ninth gate clock signal GS_CK9, an operation of the first stage may be normal. When the tenth gate signal GS10 is output based on the tenth gate clock signal GS_CK10 in the thirteenth to fourteenth horizontal times H13 to H14, the voltage of the CQ node NCQ1 of the first stage may have a low level. In addition, the first stage may not receive the tenth gate clock signal GS_CK10. Therefore, an operation of the first stage may be normal. When the eleventh gate signal GS11 is output based on the first gate clock signal GS_CK1 in the fourteenth to fifteenth horizontal times H14 to H15, the voltage of the CQ node NCQ1 of the first stage may have the low level. In addition, when the voltage of the CQ node NCQ1 has the low level, the fifteen-first to fifteen-sixth transistors T15-1 to T15-6 may be turned off. Therefore, even if the first stage receives the first gate clock signal GS_CK1, an operation of the first stage may be normal. In other words, Q may be a minimum value among Q values which satisfy a condition that the fourteenth to fifteenth horizontal times H14 to H15, which are the durations in which the eleventh gate signal GS11 of the second stage is output, are separated from a duration in which the voltage of the CQ node NCQ1 of the first stage has the high level.

The operation may also be applied to the second stage, the third stage, the fourth stage, the fifth stage, etc.

As such, in a gate driver 130 and a display device 10, Q may be a minimum value among Q values that satisfy a condition that the duration in which the Q+1-th gate signal of the second stage is output is separated from a duration in which the voltage of the CQ node NCQ1 of the first stage has the high level. Accordingly, a dead space of a gate driver 130 may be reduced.

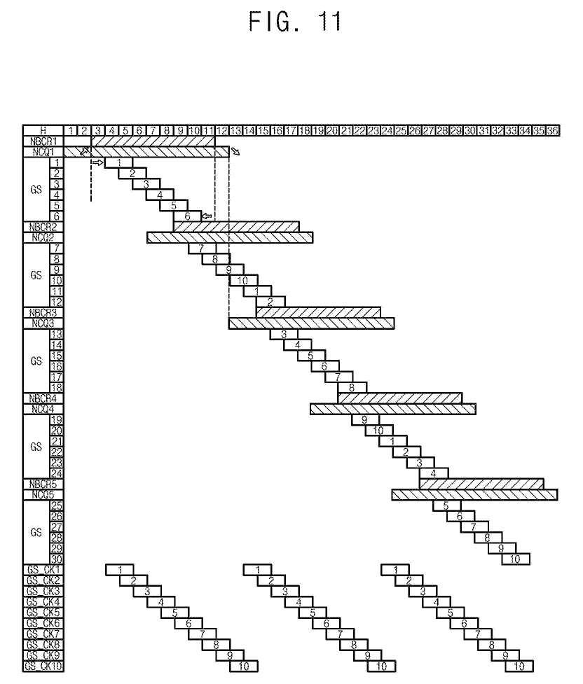

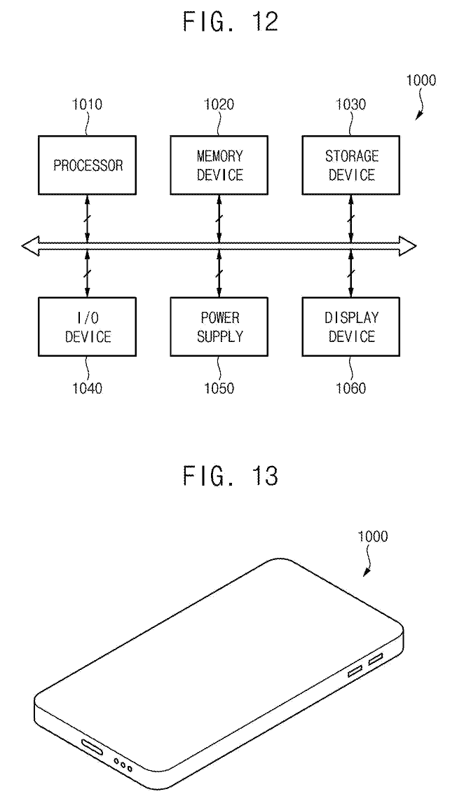

FIG. 12 is a block diagram showing an electronic device 1000. FIG. 13 is a diagram showing an embodiment in which an electronic device 1000 of FIG. 12 is implemented as a smartphone.

Referring to FIGS. 12 and 13, an electronic device 1000 may include a processor 1010, a memory device 1020, a storage device 1030, an input/output I/O device 1040, a power supply 1050, and a display device 1060. The display device 1060 may be the display device 100 of FIG. 1. In addition, the electronic device 1000 may further include a plurality of ports for communicating with, e.g., a video card, a sound card, a memory card, a universal serial bus USB device, other electronic device, and the like.

In an embodiment, as shown in FIG. 13, the electronic device 1000 may be implemented as a smartphone. However, the electronic device 1000 is not limited thereto. For example, the electronic device 1000 may be implemented as a cellular phone, a video phone, a smart pad, a smart phone, a tablet PC, a car navigation system, a computer monitor, a laptop, a head mounted display HMD device, and the like.

The processor 1010 may perform various computing functions. The processor 1010 may be a micro processor, a central processing unit CPU, an application processor AP, and the like. The processor 1010 may be coupled to other components via, e.g., an address bus, a control bus, a data bus, and the like. Further, the processor 1010 may be coupled to an extended bus such as a peripheral component interconnection PCI bus.

The memory device 1020 may store data for operations of the electronic device 1000. For example, the memory device 1020 may include at least one nonvolatile memory device such as an erasable programmable read-only memory EPROM device, an electrically erasable programmable read-only memory EEPROM device, a flash memory device, a phase change random access memory PRAM device, a resistance random access memory RRAM device, a nano floating gate memory NFGM device, a polymer random access memory PoRAM device, a magnetic random access memory MRAM device, a ferroelectric random access memory FRAM device, and the like and/or at least one volatile memory device such as a dynamic random access memory DRAM device, a static random access memory SRAM device, a mobile DRAM device, and the like.

The storage device 1030 may include a solid state drive SSD device, a hard disk drive HDD device, a CD-ROM device, and the like.

The I/O device 1040 may include an input device such as, e.g., a keyboard, a keypad, a mouse device, a touch-pad, a touch-screen, and the like, and an output device such as a printer, a speaker, and the like. In some embodiments, the I/O device 1040 may include the display device 1060.

The power supply 1050 may provide power for operations of the electronic device 1000.

The display device 1060 may be connected to other components through buses or other communication links.

The inventive concepts may be applied to any display device and any electronic device including the touch panel. For example, the inventive concepts may be applied to a mobile phone, a smart phone, a tablet computer, a digital television TV, a 3D TV, a personal computer PC, a home appliance, a laptop computer, a personal digital assistant PDA, a portable multimedia player PMP, a digital camera, a music player, a portable game console, a navigation device, etc.

While the present inventive concept has been particularly shown and described with reference to embodiments thereof, it will be understood by those of ordinary skill in the art that various changes in form and detail may be made therein without departing from the spirit and scope of the present inventive concept as defined by the following claims.

What is claimed is:

1. A gate driver including a plurality of stages, wherein each of the stages comprises:
a CQ node charging circuit configured to provide a previous carry signal and a second high gate voltage to a CQ node in response to the previous carry signal;
a first CQS node charging circuit configured to provide the second high gate voltage to a CQS node in response to the previous carry signal;
a second CQS node charging circuit configured to provide a first high gate voltage to the CQS node in response to a voltage of a boosting node;
a QB node control circuit configured to invert a voltage of the CQ node to provide the inverted voltage of the CQ node to a QB node;
a CQ node boosting circuit configured to provide a boosting clock signal to the boosting node in response to the voltage of the CQ node, and to provide a second low gate voltage to the boosting node in response to a voltage of the QB node; and
a gate output circuit configured to output first to P-th (wherein P is a positive integer greater than 2) gate clock signals as first to P-th gate signals in response to the voltage of the CQ node, and to output a first low gate voltage as the first to P-th gate signals in response to the voltage of the QB node,
wherein a pulse of each of the first to P-th gate signals is included in a duration in which the voltage of the boosting node has a high level, and the duration in which the voltage of the boosting node has the high level is included in a duration in which the voltage of the CQ node has the high level,
wherein the stages receive first to Q-th (wherein Q is a positive integer greater than P) gate clock signals, and
wherein, when a first stage is configured to output first to P-th gate clock signals as first to P-th gate signals, a second stage is configured to output P+1-th to Q-th gate clock signals as P+1-th to Q-th gate signals, and then the second stage is configured to output the first gate clock signal as a Q+1-th gate signal, a duration in which the Q+1-th gate signal is output is separated from a duration in which a voltage of a CQ node of the first stage has the high level.

2. The gate driver of claim 1, wherein Q is a multiple of 2.

3. The gate driver of claim 1, wherein Q is a minimum value which satisfies a condition that the duration in which the second stage is configured to output the Q+1-th gate signal is separated from the duration in which the voltage of the CQ node of the first stage has the high level.

4. The gate driver of claim 1, wherein the gate driver is configured to support a Dual Line Gate (DLG) mode, and while the gate driver is configured to perform the DLG mode, a time length of a pulse of each of the first to Q-th gate clock signals is reduced.

5. The gate driver of claim 1, wherein P is 6 and Q is 10.

6. The gate driver of claim 1, wherein the CQ node charging circuit comprises:
a first-first transistor including a gate electrode that receives the previous carry signal, a first electrode that receives the previous carry signal, and a second electrode that receives the second high gate voltage; and
a first-second transistor including a gate electrode that receives the previous carry signal, a first electrode that receives the second high gate voltage, and a second electrode connected to the CQ node.

7. The gate driver of claim 1, wherein the first CQS node charging circuit comprises a first transistor including a gate electrode that receives the previous carry signal, a first electrode that receives the second high gate voltage, and a second electrode connected to the CQS node, and
wherein the second CQS node charging circuit comprises a second transistor including a gate electrode that receives the voltage of the boosting node, a first electrode that receives the first high gate voltage, and a second electrode connected to the CQS node.

8. The gate driver of claim 1, wherein the QB node control circuit comprises:
a first transistor including a gate electrode that receives the first high gate voltage, a first electrode that receives the first high gate voltage, and a second electrode;
an second transistor including a gate electrode connected to the second electrode of the first transistor, a first electrode that receives the first high gate voltage, and a second electrode connected to the QB node;
a third transistor including a gate electrode connected to the CQ node, a first electrode that receives the first low gate voltage, and a second electrode connected to the second electrode of the first transistor and the gate electrode of the second transistor; and
a fourth transistor including a gate electrode connected to the CQ node, a first electrode that receives the second low gate voltage, and a second electrode connected to the QB node.

9. The gate driver of claim 1, wherein the CQ node boosting circuit comprises:
a first transistor including a gate electrode connected to the CQ node, a first electrode that receives the boosting clock signal, and a second electrode connected to the boosting node;
a second transistor including a gate electrode connected to the QB node, a first electrode that receives the second low gate voltage, and a second electrode connected to the boosting node; and
a CQ boost capacitor including a first electrode connected to the CQ node and a second electrode connected to the boosting node.

10. The gate driver of claim 1, wherein the gate output circuit comprises first to P-th gate output circuits configured to output the first to P-th gate signals, and
wherein the P-th gate output circuit comprises:
a P-th gate variable on transistor including a gate electrode connected to the CQS node, a first electrode connected to the CQ node, and a second electrode connected to a P-th gate Q node;
a first-P-th transistor including a gate electrode connected to the P-th gate Q node, a first electrode that receives the P-th gate clock signal, and a second electrode connected to a P-th gate node from which the P-th gate signal is output;
a second-P-th transistor including a gate electrode connected to the QB node, a first electrode that receives the first low gate voltage, and a second electrode connected to the P-th gate node; and
a P-th gate boost capacitor including a first electrode connected to the P-th gate Q node and a second electrode connected to the boosting node.

11. The gate driver of claim 1, wherein each of the stages further comprises:
a first CQ node discharging circuit configured to provide the second low gate voltage to the CQ node in response to a next carry signal; and
a second CQ node discharging circuit configured to provide the second low gate voltage to the CQ node in response to the voltage of the QB node.

12. The gate driver of claim 11, wherein the first CQ node discharging circuit comprises a first transistor including a gate electrode that receives the next carry signal, a first electrode that receives the second low gate voltage, and a second electrode connected to the CQ node, and
wherein the second CQ node discharging circuit comprises a second transistor including a gate electrode connected to the QB node, a first electrode that receives the second low gate voltage, and a second electrode connected to the CQ node.

13. The gate driver of claim 1, wherein each of the stages further comprises a third CQS node charging circuit configured to provide the first high gate voltage to the CQS node in response to a next carry signal.

14. The gate driver of claim 13, wherein the third CQS node charging circuit comprises a first transistor including a gate electrode that receives the next carry signal, a first electrode that receives the first high gate voltage, and a second electrode connected to the CQS node.

15. The gate driver of claim 1, wherein each of the stages further comprises a CQS node discharging circuit configured to provide the first low gate voltage to the CQS node in response to the voltage of the QB node.

16. The gate driver of claim 15, wherein the CQS node discharging circuit comprises a first transistor including a gate electrode connected to the QB node, a first electrode that receives the first low gate voltage, and a second electrode connected to the CQS node.

17. The gate driver of claim 1, wherein each of the stages further comprises a carry output circuit configured to output a carry clock signal as the carry signal in response to the voltage of the CQ node and to output the second low gate voltage as the carry signal in response to the voltage of the QB node.

18. The gate driver of claim 17, wherein the carry output circuit comprises:
a carry variable on transistor including a gate electrode connected to the CQS node, a first electrode connected to the CQ node, and a second electrode connected to a carry Q node;
a first transistor including a gate electrode connected to the carry Q node, a first electrode that receives the carry clock signal, and a second electrode connected to the carry node from which the carry signal is output;
a second transistor including a gate electrode connected to the QB node, a first electrode that receives the second low gate voltage, and a second electrode connected to the carry node; and
a carry boost capacitor including a first electrode connected to the carry Q node and a second electrode connected to the carry node.

19. An electronic device, comprising:
a display panel including a pixel;
a data driver configured to provide a data voltage to the pixel;
a gate driver configured to provide a gate signal to the pixel;
a driving controller configured to control the data driver and the gate driver; and
a power supply configured to provide a power to the display panel, the data driver, the gate driver, and the driving controller,
wherein the gate driver comprises a plurality of stages,
wherein each of the stages comprises:
a CQ node charging circuit configured to provide a previous carry signal and a second high gate voltage to a CQ node in response to the previous carry signal;
a first CQS node charging circuit configured to provide the second high gate voltage to a CQS node in response to the previous carry signal;
a second CQS node charging circuit configured to provide a first high gate voltage to the CQS node in response to a voltage of a boosting node;
a QB node control circuit configured to invert a voltage of the CQ node to provide the inverted voltage of the CQ node to a QB node;
a CQ node boosting circuit configured to provide a boosting clock signal to the boosting node in response to the voltage of the CQ node, and to provide a second low gate voltage to the boosting node in response to a voltage of the QB node; and
a gate output circuit configured to output first to P-th (wherein P is a positive integer greater than 2) gate clock signals as first to P-th gate signals in response to the voltage of the CQ node, and to output a first low gate voltage as the first to P-th gate signals in response to the voltage of the QB node,
wherein a pulse of each of the first to P-th gate signals is included in a duration in which the voltage of the boosting node has a high level, and the duration in which the voltage of the boosting node has the high level is included in a duration in which the voltage of the CQ node has the high level,
wherein the stages receive first to Q-th (wherein Q is a positive integer greater than P) gate clock signals, and
wherein, when a first stage is configured to output first to P-th gate clock signals as first to P-th gate signals, a second stage is configured to output P+1-th to Q-th gate clock signals as P+1-th to Q-th gate signals, and then the second stage is configured to output the first gate clock signal as Q+1-th gate signal, a duration in which the Q+1-th gate signal is output is separated from a duration in which a voltage of a CQ node of the first stage has the high level.

20. The electronic device of claim 19, wherein Q is a multiple of 2.
